(19) United States
(12) Patent Application Publication
(10) Pub. No.: US 2013/0318991 A1
(43) Pub. Date: Dec. 5, 2013

(54) Combustor With Multiple Combustion Zones With Injector Placement for Component Durability

(71) Applicants: Richard Martin DiCintio, Simpsonville, SC (US); Wei Chen, Greer, SC (US); Patrick Benedict Melton, Horse Shoe, NC (US); Lucas John Stoia, Taylors, SC (US); Mark Allan Hadley, Greer, SC (US)

(72) Inventors: Richard Martin DiCintio, Simpsonville, SC (US); Wei Chen, Greer, SC (US); Patrick Benedict Melton, Horse Shoe, NC (US); Lucas John Stoia, Taylors, SC (US); Mark Allan Hadley, Greer, SC (US)

(73) Assignee: GENERAL ELECTRIC COMPANY, Schenectady, NY (US)

(21) Appl. No.: 13/485,110

(22) Filed: May 31, 2012

(51) Int. Cl. F23R 3/34; B21D 53/00; F02C 3/04

(52) U.S. Cl. 60/774; 60/746; 60/805; 29/889.22

(57) ABSTRACT

A combustion system including a combustor; a combustor liner disposed within the combustor is provided. At least one primary fuel nozzle is provided to provide fuel to a primary combustion zone disposed proximate to the upstream end of the combustor liner. A transition duct is coupled to the downstream end of the combustor liner. A secondary nozzle assembly is disposed proximate to the downstream end of the combustor to provide fuel to a secondary combustion zone at locations predetermined to reduce peak thermal loads on the surface area of the transition duct.

### STATEMENT OF FEDERALLY SPONSORED RESEARCH

This invention was made with Government support under contract number DE-FC26-05NT42643 awarded by the Department Of Energy. The Government has certain rights in this invention.

### TECHNICAL FIELD

The subject matter disclosed herein relates generally to late lean injection systems for gas turbines, and more specifically to late lean injection systems with a nozzle assembly designed to minimize damage to combustor liners and transition ducts.

### BACKGROUND

Gas turbine systems generally include a compressor subsystem, a combustor subsystem, a fuel injection subsystem and a turbine subsystem.

Typically, the compressor subsystem pressurizes inlet air, which is then transported to the combustor subsystem where it is used to provide air to the combustion process and for cooling. The compressor subsystem includes a compressor rotor, compressor blades, a compressor stator, a compressor casing and a compressor discharge casing. A typical compressor subsystem may have a number of stages with modulating inlet guide vanes. Air may be extracted for cooling in between some of the stages.

The combustor subsystem may include at least one combustor and an ignition mechanism. The combustor may include a combustor casing, a flow sleeve, a liner, at least one nozzle and a transition piece. Each combustor includes a flow sleeve and a combustor liner substantially concentrically arranged within the flow sleeve. Both the flow sleeve and combustor liner extend between a double-walled transition piece at their downstream or aft ends, and a combustor liner cap assembly at their upstream or forward ends. Within each combustor are a cylindrical liner and a liner cap assembly. The liner, and the liner cap assembly define a combustion chamber where fuel is burned.

Each combustor may include at least one fuel nozzle that may inject fuel or an air fuel mixture into the combustion chamber. Fuel nozzles may be of various designs, including, but not limited to a tube-in-tube injector, a swirl injector, a rich catalytic injector configuration, and a multi tube nozzle design, among others.

Transition pieces direct hot gases from the combustion chamber to the turbine nozzles. The transition pieces have a circular inlet transition to an annular segment at the exit for the turbine nozzles. Seals are utilized at both connection locations to control leakage flows.

Energy from hot pressurized gas produced by the compressor subsystem and combustor subsystem is converted to mechanical energy. The turbine section is comprised of a combustion wrapper, turbine rotor, turbine shell, exhaust frame, exhaust diffuser, nozzles and diaphragms, stationary shrouds, and aft bearing assembly. The turbine rotor assembly consists of a forward shaft, at least one turbine wheel, and an aft turbine shaft and a plurality of buckets.

A turbine bucket is a bladelike vane assembled around the periphery of the turbine rotor to guide the steam or gas flow. Turbine buckets are attached to the wheel with fir tree dovetails that fit into matching cutouts at the rim of the turbine wheel. The turbine section may also have one or more sets of nozzles (stationary blades) that direct the gas flow to buckets.

Some gas turbine systems use late lean injection (LLI) systems as a way to reduce NOx formation by reducing the residence time of fuel and air within the combustor. LLI involves the injection of a portion of the fuel and air into the combustor at an axial location downstream from the main combustion zone. LLI systems can create an exhaust gas exit profile that is very harsh on gas turbine system components.

### BRIEF DESCRIPTION OF THE INVENTION

In accordance with one exemplary non-limiting embodiment, the invention relates to a combustion system including a combustor; a combustor liner disposed within the combustor. The combustor liner has an upstream end, a downstream end and a periphery. At least one primary fuel nozzle is provided to provide fuel to a primary combustion zone disposed proximate to the upstream end of the combustor liner. A transition duct having a surface area, is coupled to the downstream end of the combustor liner. A secondary nozzle assembly is disposed proximate to the downstream end of the combustor to provide fuel to a secondary combustion zone at locations predetermined to reduce peak thermal loads on the surface area of the transition duct.

In another embodiment, a gas turbine with a compressor; and a plurality of combustors coupled to the compressor is provided. Each combustor includes a combustor liner having an upstream end, a downstream end and a periphery; and at least one primary fuel nozzle to provide fuel to a primary combustion zone. The at least one primary nozzle being disposed proximate to the upstream end of the combustor liner. The combustor also includes a transition duct coupled to the downstream end of the combustor liner; and a secondary nozzle assembly disposed proximate to the downstream end of the combustor liner to provide fuel to a secondary combustion zone at locations predetermined to reduce peak thermal loads on the surface area of the transition duct.

In another embodiment, a method of managing a thermal load profile on a transition duct includes combusting a first fuel stream in a primary combustion zone proximate to an upstream end of a combustor liner; flowing combustion gases to a secondary combustion zone disposed proximate to a downstream end of the combustor liner; and injecting a second fuel stream into the secondary combustion zone through a predetermined number of nozzles disposed through the combustor liner, the predetermined number of nozzles selected to reduce peak thermal loads on a surface of a transition duct coupled to the combustor liner.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cross sectional view of an embodiment of a combustor including a secondary nozzle assembly.

FIG. 2 is a side view of an embodiment combustor liner aft section and a transition duct.

FIG. 3 is a cross-sectional view across an embodiment of a combustor liner aft section showing the angular positions of the secondary nozzles.

FIG. 4 is a cross sectional view across a first embodiment of a combustor liner aft section, showing the angular disposition of the secondary nozzles.

FIG. 5 is a top view of the first embodiment a combustor liner aft section and a transition duct showing thermal load distribution on the surface.

FIG. 6 is a first side view of the first embodiment of a combustor liner aft section and a transition duct showing thermal load distribution on the surface.

FIG. 7 is a second side view of the first embodiment of a combustor liner aft section and a transition duct showing thermal load distribution on the surface.

FIG. 8 is a cross sectional view across a second embodiment of a combustor liner aft section, showing the angular disposition of the secondary nozzles.

FIG. 9 is a top view of the second embodiment of a combustor liner aft section and a transition duct showing thermal load distribution on the surface.

FIG. 10 is a first side view of the second embodiment of a combustor liner aft section and a transition duct showing thermal load distribution on the surface.

FIG. 11 is a second side view of the second embodiment of a combustor liner aft section and a transition duct showing thermal load distribution on the surface

FIG. 12 is a cross sectional view across a third embodiment of a combustor liner aft section, showing the angular disposition of the secondary nozzles.

FIG. 13 a top view of a third embodiment of a combustor liner aft section and a transition duct showing thermal load distribution on the surface.

FIG. 14 is a first side view of the third embodiment of a combustor liner aft section and a transition duct showing thermal load distribution on the surface.

FIG. 15 is a second side view of the third embodiment of a combustor liner aft section and a transition duct showing thermal load distribution on the surface.

FIG. 16 is a chart illustrating the exit profile distribution of an embodiment.

FIG. 17 is a flowchart illustrating a method of managing the thermal load profile on a transition duct.

FIG. 18 is a flowchart illustrating a method of fabricating a combustor liner.

FIG. 19 is a schematic of a turbine system with a late lean injection system.

### DETAILED DESCRIPTION OF THE INVENTION

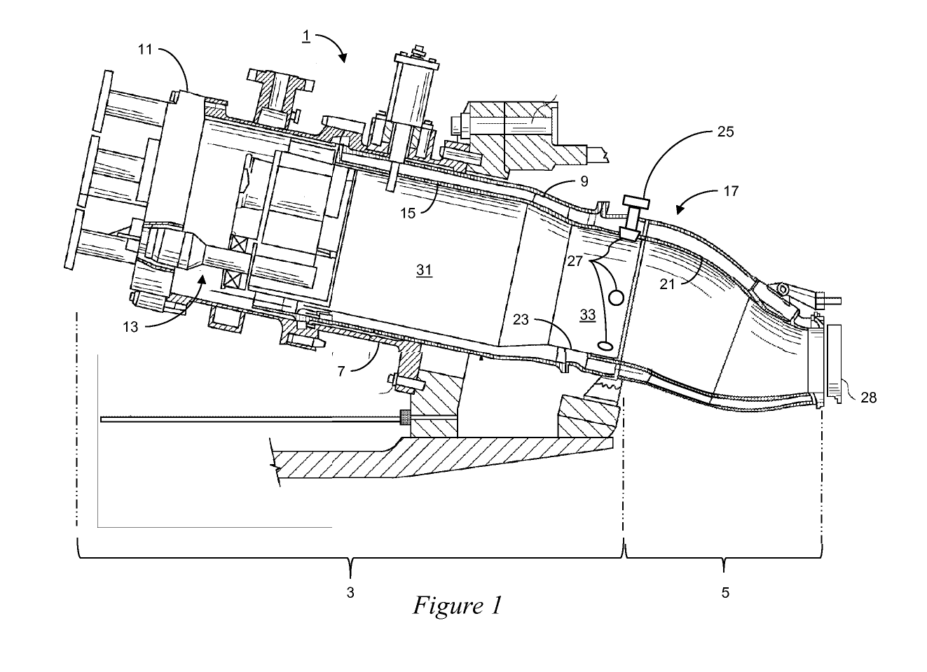

Illustrated in FIG. 1 is an embodiment of a late lean injection system (LLI system 1). The LLI system 1 includes a combustor assembly 3, and a transition duct assembly 5. The combustor assembly 3 may include a combustor casing 7, a flow sleeve 9, and an end cover assembly 11. The combustor assembly three also includes a primary nozzle assembly 13 coupled to a fuel source (not shown) and a combustor liner 15. The transition duct assembly 5 includes a transition duct having an interior transition duct wall 21. The combustor liner 15 includes a combustor liner aft section 23 adapted to support a secondary nozzle assembly 25 coupled to a fuel source (not shown) that may have one or more secondary nozzles 27. Exhaust gases from combustor assembly 3 are used to drive a turbine (represented by single blade 28).

The combustor liner 15 and the end cover assembly 11 define a primary combustion zone 31 and a secondary combustion zone 33. The secondary nozzle assembly 25 injects a portion of the fuel and air into the secondary combustion zone 33 at an axial location downstream from the primary combustion zone 31.

The fuel and air combusted in the secondary combustion zone 33 does not travel as far through the combustor as they otherwise would if there were not a secondary nozzle assembly 25. As such, as long as sufficient fuel and air mixing occurs, the fuel and air combusted in the primary combustion zone 31 and the secondary combustion zone 33 generally do not form as much NOx as would otherwise be produced.

The number and location of secondary nozzles 27 have a significant impact on the thermal load distribution on the surface of the transition duct or 17 and the combustor liner aft section 23. The thermal load is the amount of heat energy crossing a unit area per unit time per unit temperature. This impact can be demonstrated using computational fluid dynamics (CFD) analysis.

CFD is used to accurately calculate the heat transfer from the hot gas stream to the various components using numerical methods rather than model experiments. Computers are used to perform the calculations required to simulate the interaction of liquids and gases with surfaces defined by boundary conditions. Typically CFD requires detailed information of the geometry of both the flow channel (e.g. a virtual combustor liner 15 and transition duct 17) and the different components that disturb the flow such as nozzles, and fuel injection. From CFD analysis of the gas flow through the combustor liner 15 and the transition duct 17, values for the thermal load are obtained at locations throughout the components. The thermal load values indicate where hot spots occur in the components.

A series of CFD studies were performed using a virtual combustor liner aft section 23 and transition duct 17 having one or more secondary nozzles 27 disposed at different locations in the periphery of combustor liner aft section 23. The results of the studies demonstrate that by locating the secondary nozzles 27 at strategic locations on the combustor liner aft section 23 a significant reduction in hot spots can be achieved.

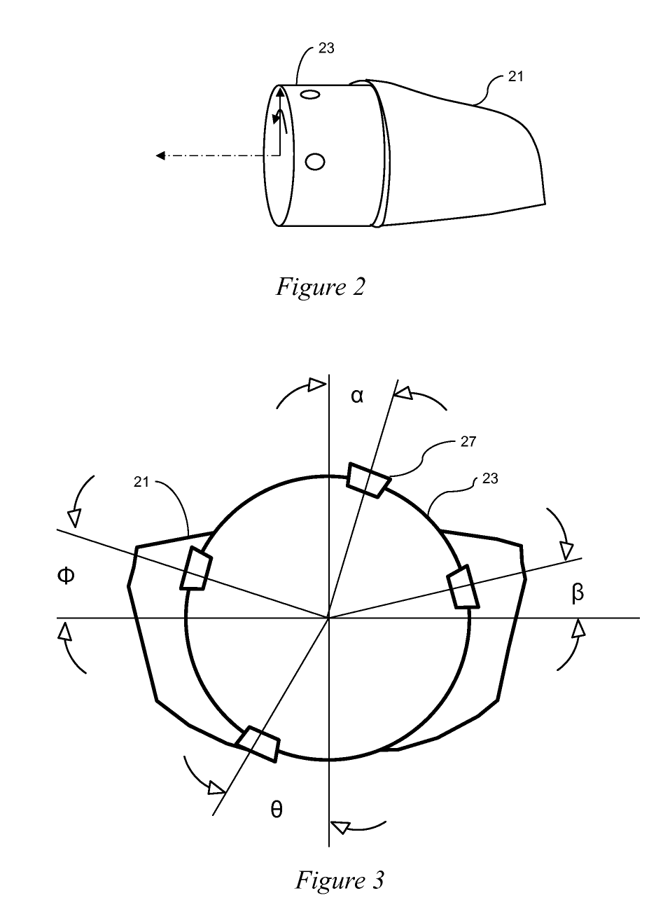

Illustrated in FIGS. 2 and 3 are a combustor liner aft section 23 and the interior transition duct wall 21. In one embodiment, illustrated in FIG. 3, four secondary nozzles 27 may be disposed around the periphery of the combustor liner aft section 23. The location of the secondary nozzles 27 may be defined by the location of hidden longitudinal axes and an angular measure. For example, in FIG. 3 the first secondary nozzle 27 is disposed at an angle a from the vertical. The second nozzles illustrated as being disposed at an angle of 90° minus 13 from the vertical. The third nozzle illustrated as disposed at an angle of 180° plus 0, and the fourth nozzle is disposed at an angle of 270° plus D.

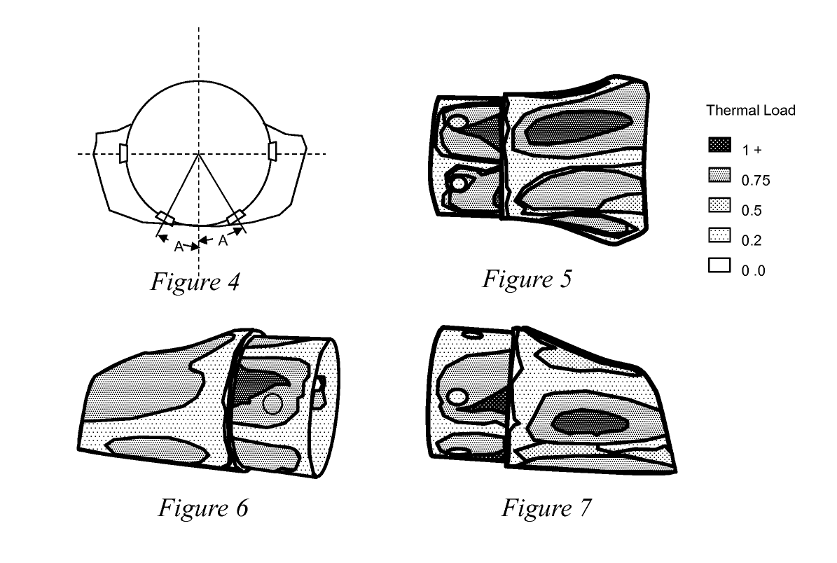

Illustrated in FIGS. 4-6 are CFD results for thermal load distribution on the surface of a virtual combustor liner aft section 23, and a virtual interior transition duct wall 21. In the examples in FIG. 4-7 four (4) secondary nozzles 27 are disposed around the periphery of the combustor liner aft section 23 in a configuration where α is equal to 90°, β is equal to A°, θ Is equal to A° and Φ is equal to 0°. FIG. 5 illustrates the thermal load distribution along for the top of the combustor liner aft section 23 and interior transition duct wall 21. FIG. 6 illustrates the thermal load distribution along a first side of the combustor liner aft section 23 and interior transition duct wall 21. FIG. 7 illustrates the thermal load distribution along a second side of the combustor liner aft section 23 and interior transition duct wall 21. As FIGS. 4-6 illustrate, significant hot spots (thermal load>400) are evident in this configuration. These hot spots would negatively affect the life of a real combustor liner aft section 23 and interior transition duct wall 21.

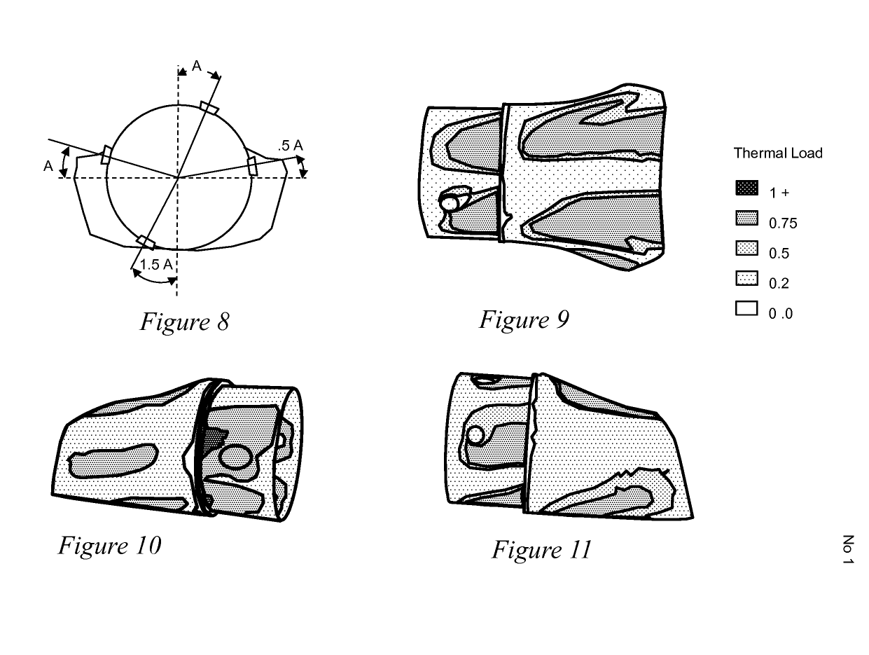

In the examples in FIGS. 8-11 four (4) secondary nozzles 27 are disposed around the periphery of the combustor liner aft section 23 in a configuration where α is equal to A°, β is equal to 0.5×A°, θ Is equal to 1.5×A° and Φ is equal to A°. FIG. 9 illustrates the thermal load distribution along for the top of the combustor liner aft section 23 and interior transition duct wall 21. FIG. 10 illustrates the thermal load distribution along a first side of the combustor liner aft section 23 and interior transition duct wall 21. FIG. 11 illustrates the thermal load distribution along a second side of the combustor liner aft section 23 and interior transition duct wall 21. As FIGS. 6 -8 illustrate, there is a significant reduction in hot spots in this configuration when compared with FIGS. 4-6. This would result in a combustor liner aft section 23 and interior transition duct wall 21 with a longer product life.

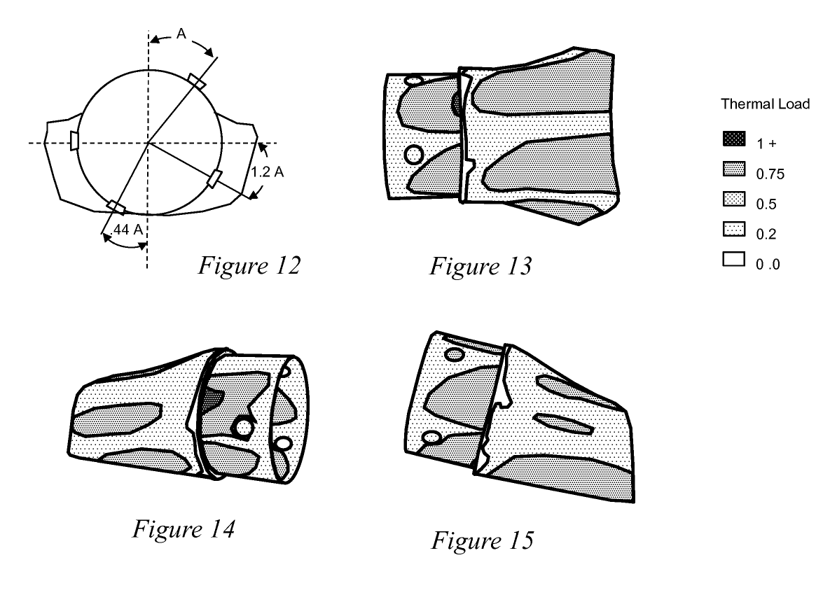

In the example in FIGS. 12-15 four (4) secondary nozzles 27 are disposed around the periphery of the combustor aft liner section 23 in a configuration where α is equal to A°, β is equal to 1.2×A°, θ Is equal to 0.44×A° and Φ is equal to B°. FIG. 13 illustrates the thermal load distribution along for the top of the combustor liner aft section 23 and interior transition duct wall 21. FIG. 14 illustrates the thermal load distribution along a first side of the combustor liner aft section 23 and interior transition duct wall 21. FIG. 15 illustrates the thermal load distribution along a second side of the combustor liner aft section 23 and interior transition duct wall 21. As FIGS. 10-12 illustrate, there is a significant reduction in hot spots in this configuration when compared with FIGS. 4-6. The reduction in hot spots would result in a combustor liner aft section 23 and interior transition duct wall 21 with a longer product life

An additional advantage of the placement of the secondary nozzles 27 is a more favorable exit profile at the transition duct exit. Engine manufacturers assess thermal gradient performance by specifying and measuring a combustor's exit profile.

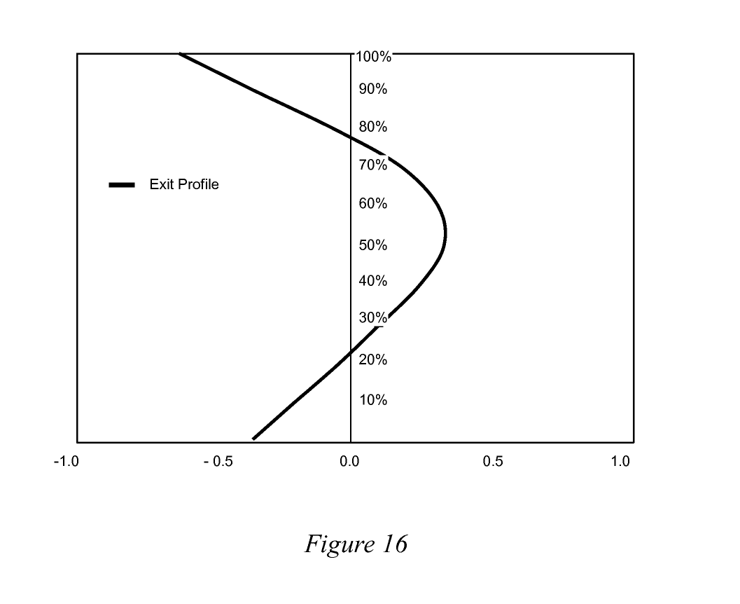

The goal is for the actual profile to match the design profile. FIG. 16 is a chart showing the exit Profile calculated for the embodiment illustrated in FIGS. 12-15.

The placement and method of injection will greatly affect life of the combustor and turbine components. CFD analysis of various injection methods have shown that the impact on the components can be greatly reduced by determining the quantity and location of injectors by first determining the peak thermal loads from the head end, including the impact of swirl, then placing the secondary nozzles 27 around those head end affected areas.

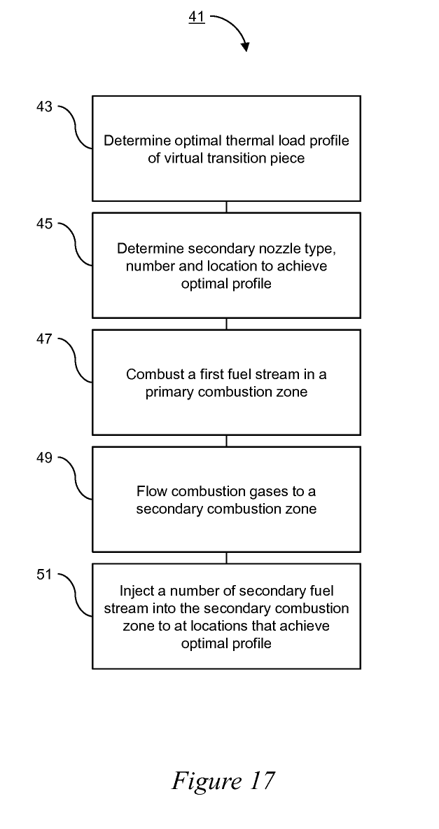

FIG. 17 is a flowchart illustrating a method to manage the thermal load profile (method 41) on a transition duct 17. In method element 43, the method 41 may determine an optimal thermal load profile of a virtual transition piece. The method 51 may determine the number and locations of the secondary nozzles 27 from the optimal thermal load profile (method element 45). The number of nozzles may be determined using CFD and the nozzles may be disposed at predetermined angles around the combustor liner, with the predetermined angles selected to reduce peak thermal load on the surface of the transition duct 17. The method 41 may combust a first fuel stream in a primary combustion zone (method element 47). The method 41 flow the combustion gases to a secondary combustion zone 33 (method element 49). The method 41 may inject a secondary fuel stream into the secondary combustion zone 33 at locations that achieve the optimal thermal load profile (method element 51). The secondary fuel stream may be injected in a radial direction into the secondary combustion zone. As used herein, “optimal thermal load profile” means a thermal load distribution on the combustor liner aft section 23 and the transition duct 17 with a minimum of hot spots. As used herein “hot spots” as used with regards to the examples in FIGS. 4-15 means preferably a thermal load of 1, more preferably an thermal load greater than 0.75 and most preferably a thermal load greater than 0.5.

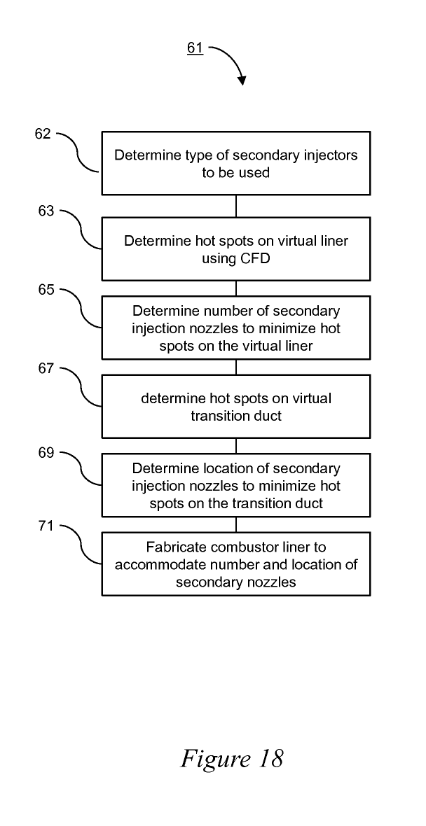

FIG. 18 is a flow chart illustrating an embodiment of a method of constructing a combustor liner (method 61). The method 61 may determine the type of secondary injectors to be used (method element 63). The method 61 may determine the hot spots that may develop on a virtual combustor liner 15 (method element 63), with a given type of secondary nozzle. This may be accomplished using CFD in a virtual combustor assembly 3 that includes the geometry of the combustor assembly 3, the combustor liner 15 and the transition duct 17. The method 61 may determine the location of the secondary injection nozzles necessary to minimize hot spots on the transition duct or virtual liner (method element 65). The quantity and location of injectors may be determined by determining the peak thermal loads from the head end (end cover assembly 11), including the impact of swirl, then placing the secondary nozzles 27 around those head end affected areas. Typically, the secondary nozzles would be located away from peak thermal load areas such that hardware life is optimized. The method 61 may determine the hot spots on the virtual transition duct (method element 67). The method 61 may determine the location of the secondary nozzles 27 that minimize hot spots on the transition duct 17 (method element 69). Based on the number and locations of secondary nozzles 27 method 61 may fabricate a real combustor liner to accommodate the type, number, and location of secondary nozzles 27 (method element 71).

The systems and methods disclosed herein provide significant hardware durability improvements and reduced repair costs. Additionally, the systems and methods disclosed herein allow for the introduction of new technologies by extending the margin on hardware life. The operability window LLI system 1 can be used to augment operability window by controlling the splits between flow through the primary combustion zone 31 and flow through the secondary combustion zone 33. In general, the operating window is limited at least one boundary by the thermal acoustic dynamics. Shifting of flow, which affects the discharge velocity, from the primary combustion zone 31 to the secondary combustion zone 33 will vary the thermal acoustic frequencies; thereafter, it will alter the resonant frequency of thermal acoustic to hardware and achieve the purpose of widening the operating window.

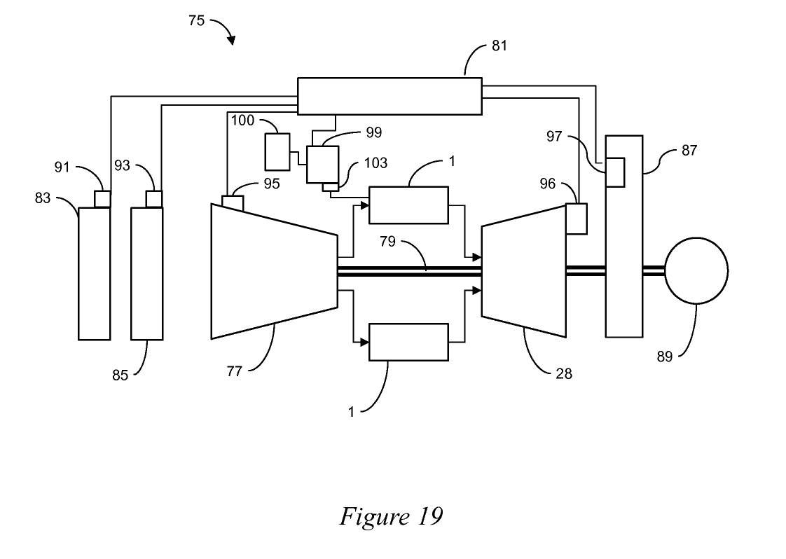

FIG. 19 depicts a gas turbine 75 having a compressor 77, one or more LLI system(s) 1, a turbine 28 and a shaft 79. The shaft 79 is coupled to the turbine 28 and compressor 77. The gas turbine 75 may also include a control system 81. An inlet duct 83 to the compressor 77 feeds ambient air and possibly injected water to the compressor 77. The inlet duct 83 may have ducts, filters, screens and sound absorbing devices that contribute to a pressure loss of ambient air flowing through the inlet duct 83 into inlet guide vanes 85 of the compressor 77. An exhaust duct 87 for directs combustion gases from the 28 turbine through, for example, emission control and sound absorbing devices.

The turbine 28 may drive a generator 89 that produces electrical power. The operation of the gas turbine 75 may be monitored by several sensors modules 91, 93, 95 and 97 having sensors that detect various conditions of the gas turbine 75 and ambient environment. For example, temperature sensors may monitor ambient temperature surrounding the gas turbine, compressor discharge temperature, turbine exhaust gas temperature, and other temperature measurements of the gas stream through the gas turbine.

Pressure sensors may monitor ambient pressure, and static and dynamic pressure levels at the compressor inlet and outlet, turbine exhaust, at other locations in the gas stream through the gas turbine. Humidity sensors 26, e.g., wet and 40 dry bulb thermometers, measure ambient humidity in the inlet duct of the compressor. The sensor modules 91, 93, 95 and 97 may also include flow sensors, speed sensors, flame detector sensors, valve position sensors, guide vane angle sensors, or the like that sense various parameters pertinent to the operation of gas turbine 75. As used herein, “parameters” refer to items that can be used to define the operating conditions of turbine, such as temperatures, pressures, and gas flows at defined locations in the gas turbine 75. These parameters can be used to represent a given turbine operating condition.

A fuel control system 99 regulates the fuel flowing from a fuel supply 100 to the LLI system 1. The fuel control system 99 may also regulate the split between the fuel flowing into primary nozzle assembly 13 and secondary nozzle assembly 25, and the fuel mixed with secondary air flowing into primary combustion zone and secondary combustion zone. The fuel control system 99 may also select the type of fuel for the LLI system 1. The fuel control system 99 may be a separate unit or may be a component of a larger control system 101. The fuel control system may also generate and implement fuel split commands that determine the portion of fuel flowing to primary nozzle assembly 13 and the portion of fuel flowing to secondary nozzle assembly 25. The control system 101 may be a General Electric SPEEDTRONIC™ Gas Turbine Control System, such as is described in Rowen, W. I., “SPEEDTRONIC™ Mark V Gas Turbine Control System”, GE-3658D, published by GE Industrial & 65 Power Systems of Schenectady, N.Y. The control system 101 may be a computer system having a processor(s) that executes programs to control the operation of the gas turbine using sensor inputs and instructions from human operators. The programs executed by the control system 101 may include scheduling algorithms for regulating fuel flow to the LLI system 1. The commands generated by the control system 101 may cause actuator 103 to regulate the flow, fuel splits and type of fuel flowing to the combustors.

LLI system 1 can be used to augment operability window by controlling the splits between the flow of fuel to the primary nozzle assembly 13 and the secondary nozzle assembly 25. In general, in addition to the thermal load to the components, the operating window of gas turbine 75 may be limited, by thermal acoustic dynamics. Shifting the proportion of the flow in the primary combustion zone 31 and secondary combustion zone 33, affects the discharge velocity, which in turn will change the thermal acoustic frequencies. The change in the thermal acoustic frequency will alter the resonant frequency of the hardware to the thermal acoustics and achieve the purpose of widening the operating window while maintaining the thermal load within acceptable values.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof

What is claimed:

1. A combustion system comprising:
a combustor;
a combustor liner disposed within the combustor, the combustor liner having an upstream end, a downstream end and a periphery;
at least one primary fuel nozzle to provide fuel to a primary combustion zone disposed proximate to the upstream end of the combustor liner;
a transition duct having a surface area, the transition duct being coupled to the downstream end of the combustor liner; and
a secondary nozzle assembly disposed proximate to the downstream end of the combustor to provide fuel to a secondary combustion zone at locations predetermined to reduce peak thermal loads on the surface area of the transition duct.

2. The combustion system of claim 1 wherein the secondary nozzle assembly comprises a predetermined number of secondary nozzles, the predetermined number of secondary nozzles selected to reduce peak thermal loads on the surface area of the transition duct.

3. The combustion system of claim 2 wherein the predetermined number of secondary nozzles are disposed through the periphery of the combustor liner.

4. The combustion system of claim 3 wherein the predetermined number of secondary nozzles are disposed at predetermined angles around the periphery of the combustor liner, the predetermined angles selected to reduce peak thermal loads on the surface area of the transition duct.

5. The combustion system of claim 2 wherein the predetermined number of secondary nozzles are determined using a computational fluid dynamics application that determines a thermal load distribution on the surface area of the transition duct.

6. The combustion system of claim 2 wherein the predetermined number of secondary nozzles is four.

7. The combustion system of claim 2 wherein the predetermined number of secondary nozzles inject fuel in a radial direction into the secondary combustion zone.

8. The combustion system of claim 2 wherein the combustor liner and transition duct are combined into a single component.

9. A gas turbine comprising
a compressor;
a plurality of combustors coupled to the compressor, each of the plurality of combustors having:
a combustor liner having an upstream end, a downstream end and a periphery;
at least one primary fuel nozzle to provide fuel to a primary combustion zone disposed proximate to the upstream end of the combustor liner;
a transition duct having a surface area, the transition duct being coupled to the downstream end of the combustor liner; and
a secondary nozzle assembly disposed proximate to the downstream end of the combustor liner to provide fuel to a secondary combustion zone at locations predetermined to reduce peak thermal loads on the surface area of the transition duct.

10. The gas turbine of claim 9 wherein the secondary nozzle assembly comprises at least one secondary nozzle disposed to reduce peak thermal loads on the surface area of the transition duct.

11. The gas turbine of claim 10 wherein the at least one secondary nozzle is disposed through the periphery of the combustor liner.

12. The gas turbine of claim 9 wherein the secondary nozzle assembly comprises a plurality of nozzles disposed at predetermined angles around the periphery of the combustor liner, the predetermined angles selected to reduce peak thermal loads on the surface area of the transition duct.

13. The gas turbine of claim 9 wherein the secondary nozzle assembly comprises a predetermined number of nozzles determined using a computational fluid dynamics application that determines a thermal load distribution on the surface area of the transition duct.

14. The gas turbine of claim 11 wherein the predetermined number of nozzles is four.

15. The gas turbine of claim 10 wherein the at least one secondary nozzle injects fuel in a radial direction into the secondary combustion zone.

16. The gas turbine of claim 10 wherein the combustor liner and transition duct are combined into a single component.

17. A method of managing a thermal load profile on a transition duct comprising:
combusting a first fuel stream in a primary combustion zone proximate to an upstream end of a combustor liner;
flowing combustion gases to a secondary combustion zone disposed proximate to a downstream end of the combustor liner; and
injecting a second fuel stream into the secondary combustion zone through a predetermined number of nozzles disposed through the combustor liner, the predetermined number of nozzles selected to reduce peak thermal loads on a surface of a transition duct coupled to the combustor liner.

18. The method of claim 17 wherein the method element of injecting a second fuel stream comprises injecting a second fuel stream through a predetermined number of nozzles that are disposed at predetermined angles around the combustor liner, the predetermined angles selected to reduce peak thermal loads on the surface of the transition duct.

19. The method of claim 18 wherein the predetermined number of nozzles are determined using a computational fluid dynamics application that determines a thermal load distribution on the surface of the transition duct.

20. The method of claim 19 wherein the method element of injecting the second fuel stream comprises injecting a second fuel stream in a radial direction into the secondary combustion zone.

21. The method of claim 20 wherein the predetermined number of nozzles comprises a plurality of nozzles.

22. The method of claim 21 wherein the plurality of nozzles comprises at least four nozzles.

23. A method of constructing a combustor subsystem for a gas turbine comprising:
determining at least one hot spot location in a virtual liner using CFD;
determining an optimal number of injection nozzles based on the at least one hot spot location; and
fabricating a real liner having the optimal number of injection nozzles.

24. The method of claim 23 further comprising:
determining a thermal load profile of a virtual transition piece coupled to the virtual liner based on the optimal number of injection nozzles;
varying the virtual locations of the optimal number of injection nozzles and determining a new thermal load profile for each set of virtual locations; and
determining optimal virtual locations of the optimal number of injection nozzles based on the thermal load profile for each set of virtual locations.

25. The method of claim 24 wherein the method element of fabricating a real liner comprises fabricating the real liner having the optimal number of injection nozzles disposed at locations corresponding to the optimal virtual locations.

26. The method of claim 25 wherein the optimal virtual locations are locations where the thermal load profile of the transition piece shows a lower number of transition piece hot spots.

27. The method of claim 25 wherein the real liner is combined with a real transition piece into a single component.
